(19) United States
(12) Patent Application Publication
(10) Pub. No.: US 2007/0220674 A1
(43) Pub. Date: Sep. 27, 2007

(54) Antibacterial-based system and method for prevention of separation anxiety

(76) Inventors: Richard Haskins, Los Angeles, CA (US); Mindy E. Rothstein, Los Angeles, CA (US)

Correspondence Address: Elliott N. Kramsky, Esq., Suite 400, 5850 Canoga Avenue, Woodland Hills, CA, 91367, US

(21) Appl. No.: 11/385,280

(22) Filed: Mar. 22, 2006

(51) Int. Cl. A47G 9/02

(52) U.S. Cl. 5/485; 5/482; 2/69.5

(57) ABSTRACT

A system and method for the transfer of an absent human's distinctive scent to a dependent, either human (infant) or a pet. A pad, which acts as the transfer medium, is worn by the human to absorb its distinctive pheronomes and odors. The pad is thereafter inserted into a pocket provided within a blanket. The blanket comprises fabric that includes silver-based antimicrobial fibers for preventing the growth of bacterial sources of scent-masking odors.

### BACKGROUND

1. Field of the Invention

The present invention relates to the bonding process that is applicable to both (human) mother-infant and (human) owner-pet interactions. More particularly, this invention pertains to a system and method for transferring the comforting presence of the scent of a familiar, though absent, human being to proximity to either an infant child or a devoted pet to minimize the effects of separation anxiety.

2. Description of the Prior Art

Separation anxiety is recognized as a major influence in infant (i.e. up to approximately 3 months) development. It is understood that it can even affect long term mental health.

Even the most devoted mother must separate physically from her infant at times to address her own needs and to permit the child to sleep, etc. Dealing with separation anxiety becomes a particularly vexing issue for the single or working mother of today who may be confronted with numerous non-traditional responsibilities during the critical period of early childhood development.

This phenomenon is also recognized to afflict human-pet nurturing.

### SUMMARY OF THE INVENTION

The present invention addresses the preceding and other shortcomings of the prior art by providing, in a first aspect, a system for delivering a the scent of an absent human to a dependent. Such system includes a blanket and a pad of scent-absorbent material. A pocket element is fixed to the blanket for receiving the pad. The blanket is of woven silver-based antimicrobial fabric.

In a second aspect, the invention provides a bonding method. The method is begun by providing a blanket comprising woven silver-based antimicrobial fibers that includes a pocket and a pad of scent-absorbent material.

The pad is contacted to a human's body for a predetermined amount of time sufficient to the human's scent. Thereafter, the pad is inserted into the pocket and a dependent then wrapped in the blanket in such a manner that it is able to inhale the scent absorbed into the pad.

The foregoing and other features of the invention will become further apparent from the detailed description that follows. Such description is accompanied by a set of drawing figures. Numerals of the drawing figures, corresponding to those of the written description, point to the features of the invention with like numerals referring to like features throughout both the written description and the drawing figures.

### BRIEF DESCRIPTION OF THE DRAWINGS

FIGS. 1(a) through 1(c) are a plan view of the blanket and plan and side elevation views of the pad respectively comprising an infant bonding system in accordance with, and for practicing the method of invention; and

FIGS. 2(a) through (c) a comprise a series of views for illustrating the process for transferring a human's scent to a blanket in accordance with an embodiment of the invention.

### DETAILED DESCRIPTION OF THE PREFERRED EMBODIMENT

The present invention relies upon the concept that separation anxiety is minimized by embedding a mother's unique scent(s) into an infant's swaddling blanket. Such scent(s) comprise both odors (scents detected consciously through the body's olfactory system) and pheronomes (scents detected subconsciously through the body's vomeronasal system and designed to convey information to and from others to trigger a response). Detection of the mother's odor and pheromones by the infant is comforting in the mother's absence.

Like processes affect the bond that is recognized to exist between a human and his or her non-human pet. In fact, due to the often significantly greater development of the sense of smell in an animal, such as a dog, pheronome detection often plays a very significant function in training and domestication. Due to the crossover that exists between human-pet and human-human (mother-infant) physiological interactions, it will be understood that the invention to be described is application to both of such relationships, which are hereafter identified generically as “human-dependent” relationships.

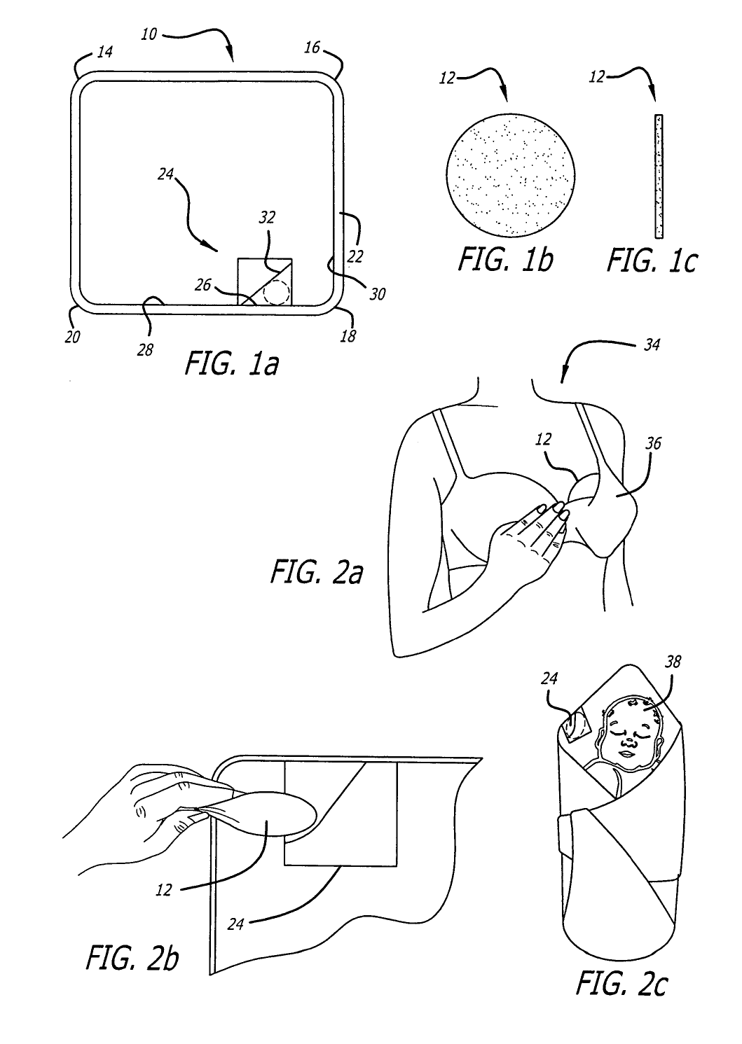

The elements of a system for delivery of a mother's scent are illustrated in FIGS. 1(a) through 1(c). They include a blanket 10 (shown in plan view in FIG. 1(a)) and a pad 12 (shown in plan and side elevations in FIGS. 1(b) and 1(c) respectively). The sheetlike pad 12 preferably serves as the medium for transferring the bonding scent from the mother to the infant. It preferably comprises non-woven organic cotton or other material conducive to the retention of the mother's scent molecules. As a consequence of its receptivity to scent-related molecules, the pad 12 is a disposable item that should be replaced after, at most, two day's use in the blanket 10.

The blanket 10 is preferably of square shape (to facilitate the weaving process) formed of one or two layers of material that may have a variety of printed designs or finishes. It may have a number of dimensions (e.g. 68 inches by 68 inches) and preferably includes rounded corners 14 through 20 although the dimensions and shape of the blanket 10 may vary within the scope of the invention. The edges of the blanket may be finished with rib knit 22, preferably of cotton, or like binding sewn to the peripheral edge of the blanket 10.

The blanket 10 includes a pocket 24 for receiving the pad 12. Such pocket 24 is formed by sewing a properly-sized piece of material to the blanket 10 so that an edge 26 of the pouch 24 coincides with a peripheral edge 28 of the blanket 10 and the pouch 24 is located a predetermined distance (e.g. 6 inches) from the nearest adjacent edge 30 of the blanket 10.

The material forming the pouch 24 is generally shaped as a right triangle with a hypotenuse edge 32 unstitched to the blanket 10 to thereby provide a location for insertion of the pad 12 (shown in shadow outline). As can be seen, the pad 24 is of sufficient size to enclose the pad 12 fully upon transfer from the mother (discussed below).

The blanket 10 (including the pouch 24) is of antibacterial fabric. As discussed above, the invention is based upon the transfer of a mother's pheronome molecules to proximity to an infant. Maximum benefit is obtained when the scent resulting from the molecules captured by the transfer medium (i.e. the pad 12) need not “compete” with various odors arising from the presence of bacteria in the blanket 10.

In a first embodiment of the invention, the blanket 10 is formed of an antibacterial fabric that is commercially available from Foss Manufacturing Company, Inc. of Hampton, N.H. under the trademark FOSSFIBRE®. Such antimicrobial material includes AgION™ all natural silver, an antimicrobial agent known to be effective against more than 650 strains of bacteria and is known to inhibit the growth of odor causing bacteria. The material has been tested and established as safe for human contact. Laboratory testing has measured kill rates of 99.99 percent against some odor causing bacteria. Among other advantages of such material in the context of the claimed invention is the continuation of antimicrobial activity in FOSSFIBRE® over material lifetimes that have included 100 commercial launderings.

A presently-preferred material for a blanket 10 comprising antimicrobial fibers for inhibiting the growth of odor causing bacteria that would otherwise inhibit the bonding effect of pheronomes embedded in the pad 12 would be woven from yarn of 60 percent cotton and 40 percent FOSSHIELD® fiber blend. By blending the odor-adsorbent fibers of FOSSHIELD® with cotton, one obtains a woven fabric having a natural feel that is particularly important for applications wherein the dependent is an infant with tender skin.

The method of the invention is illustrated with reference to human mother-infant bonding by the series of FIGS. 2(a) through 2(c). The benefits of odor recognition are studied and disclosed, for example, in the article of Rattaz, Goubert and Bullinger, “The Calming Effect of a Familiar Odor on Full-Term Newborns”, Journal of Developmental & Behavioral Pediatrics, vol. 26, no. 2 (April 2005), pgs. 86 through 92.

In FIG. 2(a) a mother 34 inserts the pad 12 under her bra 36. It is left the for a sufficient period of time to allow the pad 12 to absorb the mother's pheronomes and scents. This will preferable occur prior to separation of mother from infant. Thereafter, as shown in FIG. 2(b), the pad 12, having been removed from contact with the mother's body (for optimum absorption of pheronomes, the pad 12 may contact the mother anywhere within the region bounded by her bosom and navel), it is then inserted into the pocket 24 of the blanket 10. Finally, as shown in FIG. 2(c), the baby 38 is wrapped in the blanket 10 in such a way that his or her nose is in close proximity to the pocket 24 with pad 12 inserted therein.

For the case of a dependent other than an infant human being, scent absorption may occur, for example, by placing the pad 12 under a cap. This is particularly effective in a master-pet relationship where the master is either bald or balding. Thereafter, the pet is comforted when wrapped in the blanket 10 in a manner corresponding to that of an infant as illustrated in FIG. 2(c).

Thus it is seen that the present invention provides a blanket and method for reducing separation anxiety, and thereby improving the nuturing of an infant. By providing a blanket that places the scent of an absent mother within the infant's blanket, the bonding process continues and the infant is not truly separated from its mother. The reduction of separation anxiety is believed to contribute to the long term mental well being of the child.

While the invention has been described with reference to its presently preferred embodiment, it is not limited thereto. Rather, it is limited only insofar as it is defined by the following set of patent claims and includes within its scope all equivalents thereof.

1. A system for delivering a scent of an absent human to a dependent to whom the dependent is emotionally bonded comprising, in combination:
a) a blanket of generally-rectangular shape including four edges and four corners;
b) a pad comprising non-woven organic cotton for absorbing a scent of said absent human;
c) a single pocket element for receiving said pad being fixed to said blanket;
d) said single pocket element being positioned at an edge of said blanket in proximity to a corner of said blanket; and
e) said blanket comprising silver-based antimicrobial fabric.

2. A system as defined in claim 1 wherein said antimicrobial fabric comprises a blend of cotton and antimicrobial fibers.

3. A system as defined in claim 2 wherein said blend comprises 60 percent cotton and 40 percent antimicrobial fibers.

4. (canceled)

5. A system as defined in claim 1 wherein said pocket comprises a generally-triangular piece of fabric sewn onto said blanket.

6. A system as defined in claim 5 wherein said piece of fabric forms a right triangle.

7. A system as defined in claim 6 wherein one side forming said right angle is aligned with an edge of said blanket.

8. (canceled)

9. (canceled)

10. A method for comforting a dependent emotionally bonded to an absent human comprising the steps of:
a) providing a blanket of generally-rectangular shape comprising four corners, comprising silver-based antimicrobial fibers, having a pocket positioned in the region of a corner of said blanket for receiving a pad of non-woven cotton scent-absorbent material; then
b) contacting said pad to said human's body for a predetermined amount of time to thereby absorb said human's scent; then
c) inserting said pad into said pocket; and then
d) wrapping said dependent in said blanket so that the head of said dependent is positioned adjacent said region of said blanket whereby said dependent is positioned to inhale said scent absorbed into said pad.

11. (canceled)

12. A bonding method as defined in claim 10 wherein said dependent is a human infant.

13. A bonding method as defined in claim 10 wherein said dependent is a pet.
